(19) United States
(12) Patent Application Publication
(10) Pub. No.: US 2008/0072150 A1
(43) Pub. Date: Mar. 20, 2008

(54) EVENT-BASED DISPLAY AND METHODS THEREFOR

(75) Inventors: Alwin Chan, San Carlos, CA (US); Duke Fan, San Jose, CA (US); Irwin W. Coleman, Atlanta, GA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/470,583

(22) Filed: Sep. 6, 2006

(51) Int. Cl. G06F 3/00

(52) U.S. Cl. 715/708

(57) ABSTRACT

A system for presenting pertinent information to a user comprising a centralized server which stores at least one rule; a browser; and, a helper application associated with the browser, wherein the helper application retrieves the at least one rule from the centralized server, wherein the helper application can monitor user events triggered by at least the browser and the helper application, wherein the helper application processes the at least one rule when an event is triggered, and wherein the helper application causes an event-based display to be generated based on the rule processing results.

This application includes material which is subject to copyright protection. The copyright owner has no objection to the facsimile reproduction by anyone of the patent disclosure, as it appears in the Patent and Trademark Office files or records, but otherwise reserves all copyright rights.

### FIELD

The instant disclosure relates to the field of computer software, and more particularly provides an event-based information display and methods of using the same.

### BACKGROUND

As computers advance, the software that runs on them is becoming increasingly complex. Users can spend hours, or even days, reading software manuals and trying to understand even the basic features provided by many software applications. Some software manufacturers have attempted to remedy this by presenting a “tip of the day”, wherein a dialog box or other window is presented to the user each time the software is run, or once each day. Although the tips may contain information useful to users, and especially novice users, the tips are frequently dismissed without being read because they interfere with the user's use of the software.

The advent of high-speed data communications has allowed for an entirely new level of complexity to software, wherein the software's functionality changes over time. An example of such dynamic software is the Yahoo! Toolbar, distributed by Yahoo!, Inc. of Sunnyvale, Calif., the assignee of the instant patent application. Whenever Yahoo!, Inc. adds new services and features to its well-known web portal, new buttons or other user interface elements can be added to the Yahoo! Toolbar to facilitate access to these services and features. Although some users are amenable to new user interface elements being introduced to their software, most prefer to at least approve or deny the introduction of such elements. As a result, users may not be aware that certain features or services are available, or that the Yahoo! Toolbar can be used to facilitate access to these features or services.

### SUMMARY

What is needed is a system and methods for advising users that certain features or services are available, without the advisements becoming so intrusive that they are simply ignored.

Accordingly, the instant disclosure is directed to event-based displays and methods therefore that substantially obviate one or more of the problems due to limitations and disadvantages of the related art.

Additional features and advantages will be set forth in the description which follows, and in part will be apparent from this disclosure, or may be learned by practice thereof. The objectives and other advantages of the invention will be realized and attained by the structure particularly pointed out in this written description, including any claims contained herein and the appended drawings.

By monitoring a user's interactions with a computer in general, and especially interactions with specific software, it is possible to identify information, such as tips on how to use the software, that might be helpful to the user. Therefore, the instant disclosure is directed to a system for presenting pertinent information to a user comprising a centralized server which stores at least one rule; a browser; and, a helper application associated with the browser, wherein the helper application retrieves the at least one rule from the centralized server, wherein the helper application can monitor user events triggered by at least the browser and the helper application, wherein the helper application processes the at least one rule when an event is triggered, and wherein the helper application causes an event-based display to be generated based on the rule processing results.

The instant disclosure also provides a method of monitoring user interaction with a browser and presenting event-based displays relevant thereto comprising waiting for an event to be triggered by the browser; processing a rule set to determine if a rule exists that is pertinent to the event triggered by the browser; and, causing an event-based display to be presented to the user.

It is to be understood that both the foregoing general description and the following detailed description are exemplary and explanatory and are intended to provide further explanation of the disclosed event-based display and methods therefor.

### BRIEF DESCRIPTION OF THE DRAWINGS

The accompanying drawings, which are included to provide a further understanding of the disclosed event-based display and methods therefor and are incorporated in and constitute a part of this specification, illustrate various embodiments and, together with the description, serve to explain the principles of at least one embodiment of the disclosed event-based display and methods therefor.

In the drawings:

FIG. 1 is a screen capture illustrating an exemplary browser.

FIG. 2 is a screen capture illustrating an exemplary browser providing an event-based display.

FIG. 3 is a screen capture illustrating an exemplary browser after a user has interacted with an event-based display.

FIG. 4 is a screen capture illustrating an exemplary browser providing an alternative event-based display.

FIG. 5 is a screen capture illustrating an exemplary browser providing an alternative event-based display.

FIG. 6 is a flow chart illustrating an exemplary event-based display method.

FIG. 7 is an exemplary network architecture through which configuration information, rules, and the like can be distributed.

FIG. 8 is a table illustrating an exemplary feed format.

FIG. 9 is a table illustrating exemplary trigger types.

FIG. 10 is a table illustrating exemplary parameters that can be associated with a trigger.

### DETAILED DESCRIPTION

Reference will now be made in detail to embodiments of the disclosed event-based display and methods therefor, examples of which are illustrated in the accompanying drawings. Although specific reference is made herein to network browsing software, or browsers, it should be apparent that alternative software may be substituted therefor without departing from the spirit or the scope of the invention.

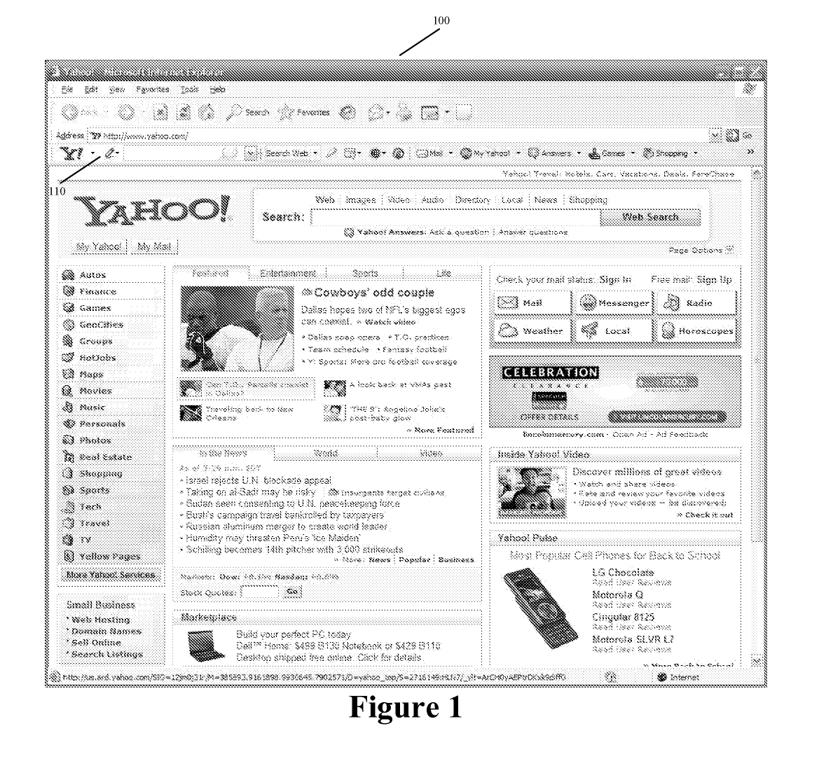

FIG. 1 is a screen capture illustrating an exemplary browser 100. Examples of such browsers include, without limitation, Internet Explorer, distributed by Microsoft Corporation of Redmond, Wash., and Firefox, distributed by Mozilla Corporation of Mountain View, Calif. Helper application 110 is associated with browser 100, and adds additional functionality to browser 100. In the illustrated embodiment, helper application 110 is a dynamic application, wherein features and functions can be added to or removed from the application by the distributor of helper application 110 or another such entity.

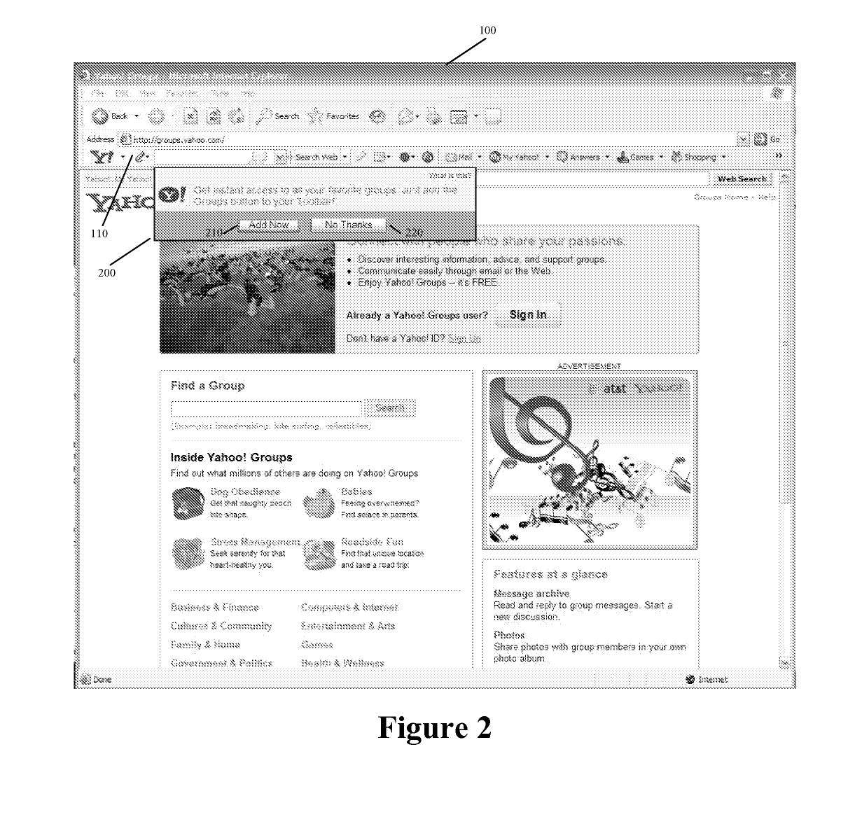

FIG. 2 is a screen capture illustrating an exemplary browser providing an event-based display. In FIG. 2, the user has used browser 100 to navigate to a Uniform Resource Locator (“URL”). When browser 100 has loaded the web page associated with the URL, browser 100 triggers an event, which can be monitored by helper application 110. When helper application 110 receives an appropriate event, helper application 110 processes the URL or the content of the page associated with the URL. Based on rules associated with helper application 110, helper application 110 may cause browser 100 to display an event-based display, such as information window 200 of FIG. 2.

In an embodiment, the rules associated with helper application 110 include one or more Hypertext Markup Language (“HTML”)-defined displays, which can be rendered by browser 100 in response to an appropriate event being triggered by browser 100. In FIG. 2, information window 200 is generated by browser 100 based on information provided by helper application 110, and permits the user to modify the features and functions available via helper application 110. In the embodiment illustrated in FIG. 2, display 200 allows the user to add a button to helper application 110 merely by clicking on or otherwise interacting with button 210 or other such user interface element. The user can decline the addition of a button to helper application 110 by clicking on or otherwise interacting with button 220.

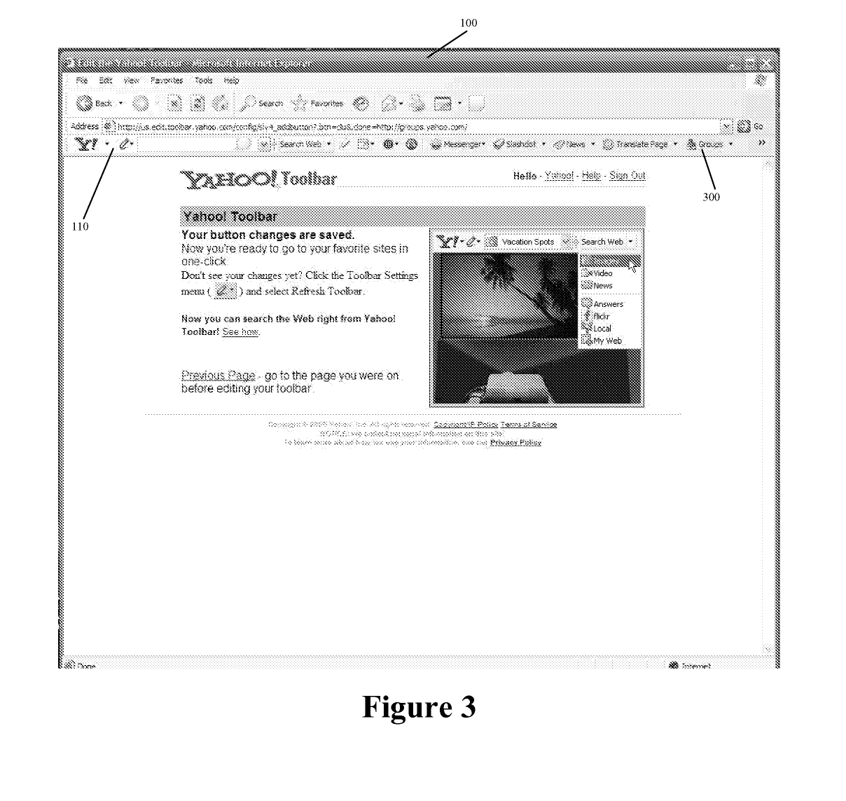

FIG. 3 is a screen capture illustrating an exemplary browser 100 and helper application 110 after a user has interacted with an event-based display. It should be noted that button 300 has been added to helper application 110 in response to the user authorizing such an addition. The addition of button 300 allows the user to more easily access the URL or other feature or function associated with button 300.

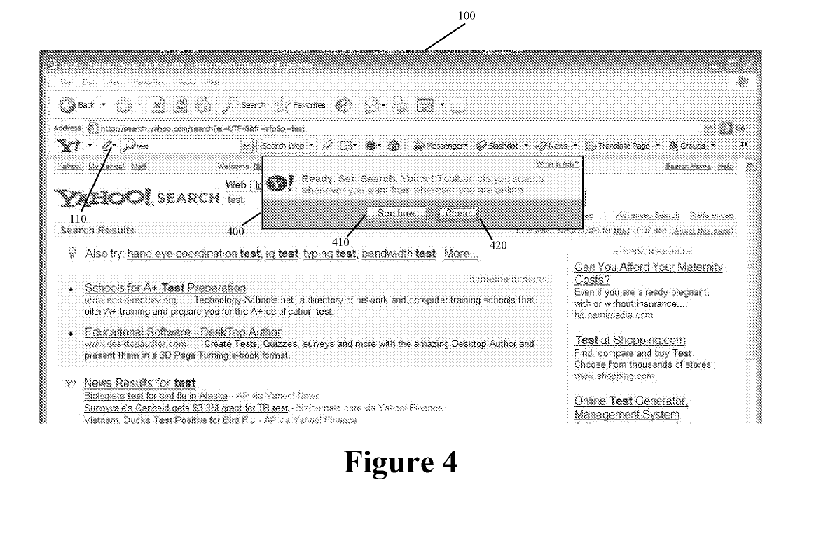

FIG. 4 is a screen capture illustrating an exemplary browser providing an alternative event-based display. In FIG. 4, the user has entered a search term in helper application 110 for the first time. Helper application 110 responds by causing browser 100 to display information window 400, though which the user can learn more about searching by clicking or otherwise interacting with button 410. The user can close information window 400 by clicking or otherwise interacting with close button 420. Information window 400 allows the user to access additional information relevant to the use of helper application 110.

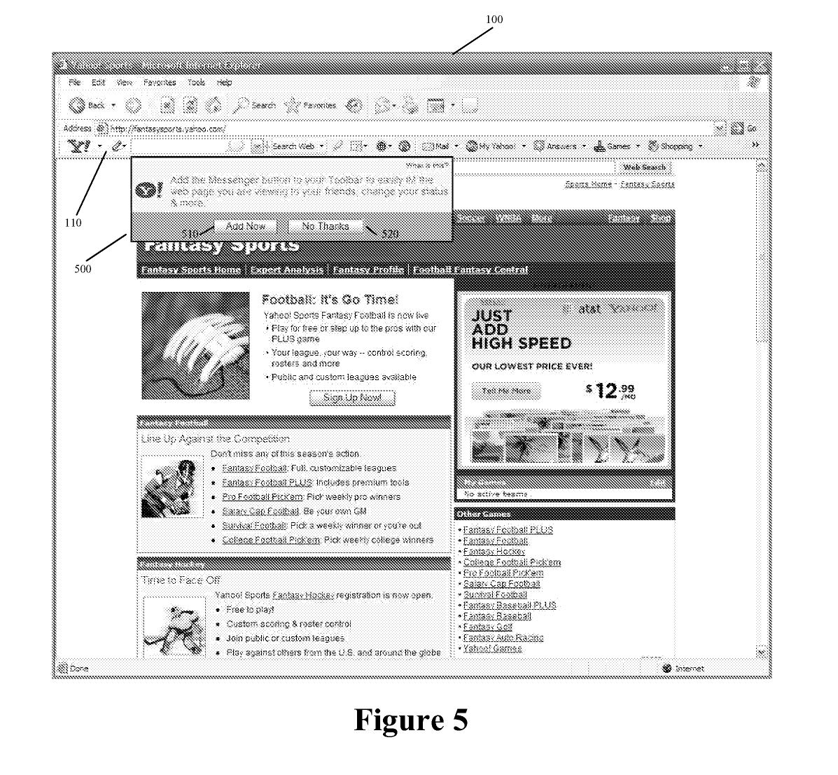

FIG. 5 is a screen capture illustrating an exemplary browser providing an alternative event-based display. In FIG. 5, helper application 110 has caused browser 100 to display information window 500 due to the expiration of a pre-defined time interval or other event not directly related to the user's interaction with browser 100 or helper application 110. The user can add the feature or function described in information window 500 by clicking or otherwise interacting with button 510 or other such user interface element, and the user can close information window 500 by clicking or otherwise interacting with button 520.

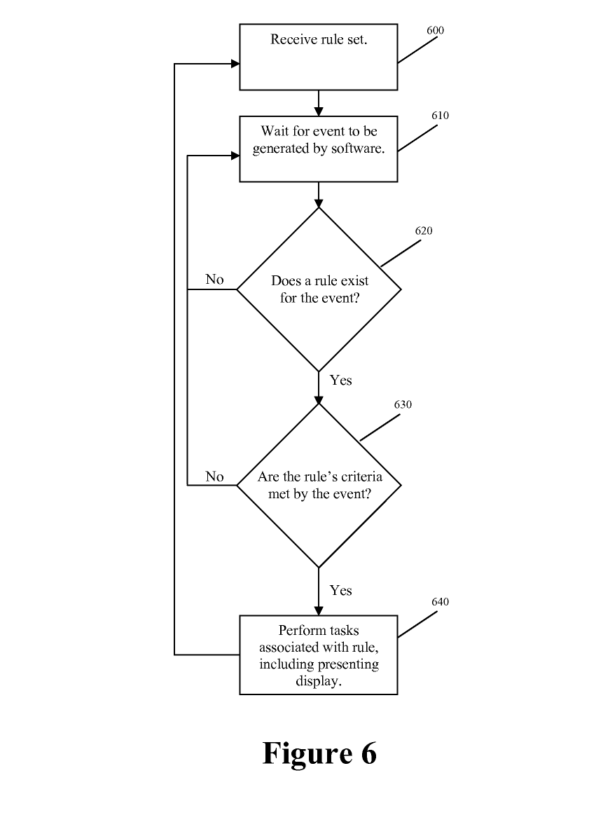

FIG. 6 is a flow chart illustrating an exemplary event-based display method. In FIG. 6, a helper application receives a rule set from a server (Block 600). The helper application then waits for a particular event to occur, such as, without limitation, the expiration of a given time period; the triggering of an event by an external application, such as a browser or the operating system; or a user's interaction with the helper application (Block 610). The helper application then determines whether a rule exists for the event (Block 620) and, if a rule does not exist, the helper application merely returns to waiting for the next event. If a rule exists for the given event (Block 620), the helper application then processes the rule to determine whether any action should be taken (Block 630). If the rule's criteria are not met, the helper application can return to waiting for the next event. If the rule's criteria are met, then the tasks associated with the rule are performed (Block 640). Such rules may include, but are not limited to, presenting an information window or other event-based display.

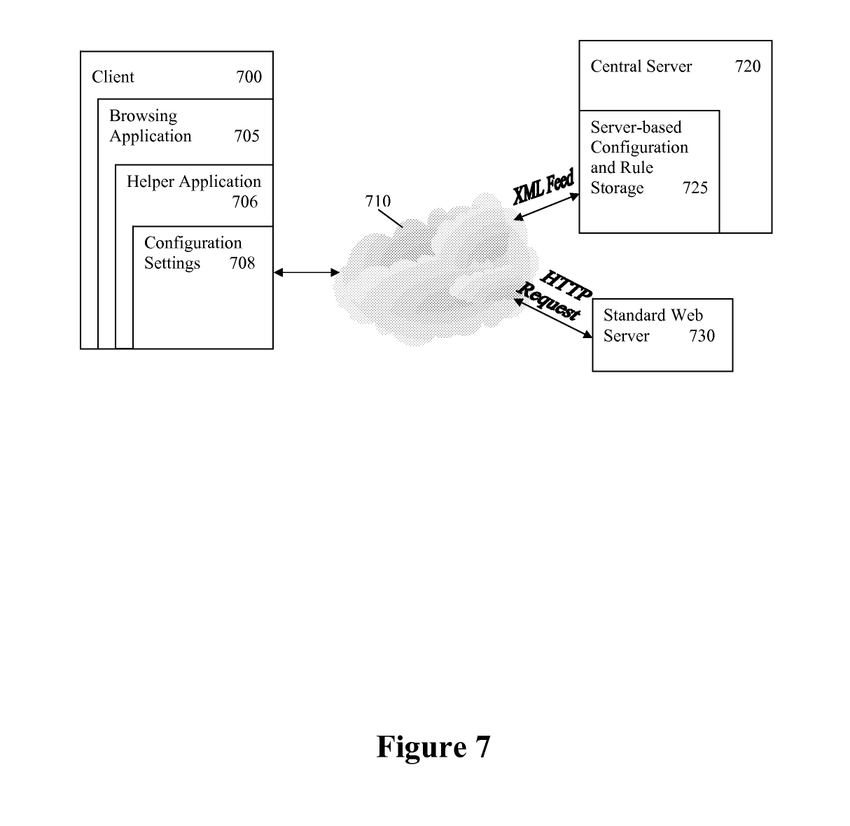

FIG. 7 is an exemplary network architecture through which configuration information, rules, and the like can be distributed. In FIG. 7, client 700 represents a user computer, cellular telephone, portable digital assistant, or other computing device. Browsing application 705 represents a browser or custom application which incorporates at least some browser-like features, and which runs on client 700. Browsing application 705 can be used to display information from a standard web server 730 or other such system capable of providing information suitable for browsing application 705.

Helper application 706 represents an application associated with browsing application 705. By way of example, without limitation, helper application 706 can be additional features integrated into a traditional browser, features added to a browser by way of a “plug-in”, or features added by way of other such well-known techniques.

When helper application 706 is loaded, helper application 706 can retrieve rules and other configuration settings 708 from one or more configuration and rule storage database 725 hosted by one or more centralized servers 720. Such rules and other configuration information may be obtained via a public telecommunications network, such as Internet 710, or a private or shared communications network.

Configuration settings 708 include rules associated with helper application 706. Such rules can assist helper application in determining when an information window should be displayed by browsing application 705. By periodically retrieving the configuration settings, helper application 706 can ensure the user has access to the latest features and functions. By incorporating event-based display rules into the configuration settings, helper application 706 can also ensure that users are aware of such features and functions.

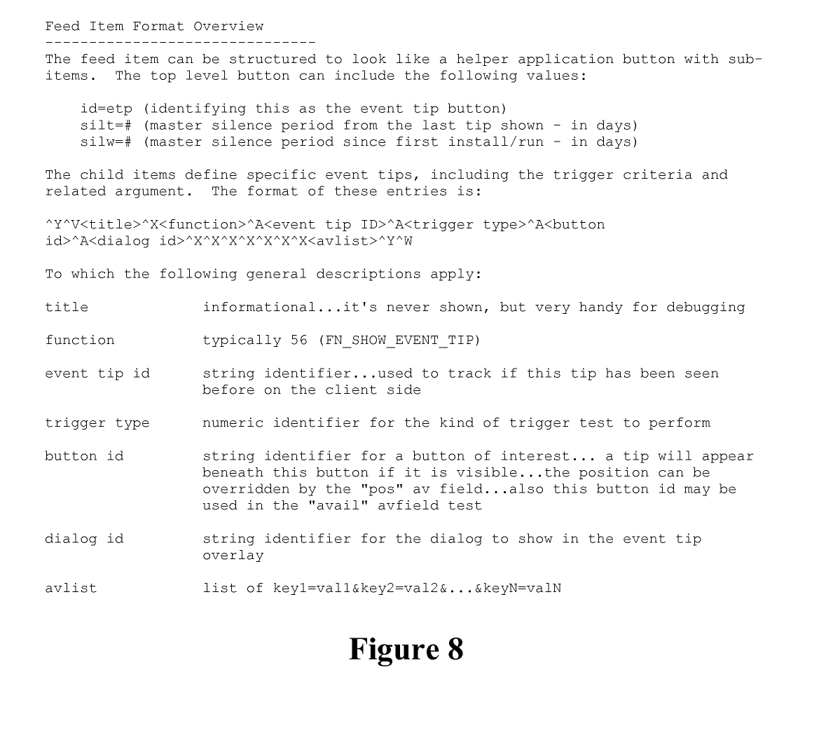

FIG. 8 is a table illustrating an exemplary feed format that incorporates rules that help determine when an information window should be displayed by a browser. Although a specific feed format embodiment is described herein, it should be apparent that alternative feed formats, including feed formats based on eXtensible Markup Language (“XML”), Standardized Generalized Markup Language (“SGML”), or the like can be substituted therefor without departing from the spirit or the scope of the invention.

The exemplary feed format can be structured to look like a helper application button, including one or more helper application button sub-items, thereby permitting the rules and related information to be transmitted to the helper application while taking advantage of existing data exchanges between the helper application and a centralized server. In the embodiment illustrated in FIG. 8, each of these helper application buttons has associated therewith an identifier type of “etp”, which allows the helper application to distinguish information display rules from other information used by the helper application. In an embodiment, a single helper application button definition can comprise a plurality of information display rules. Each information display rule can also have associated therewith master parameters controlling the interval between information window displays (“silt”) and the interval between the installation of the helper application and the display of a first information window (“silw”). Each information display rule can also have associated therewith a string comprising a plurality of attributes separated by special characters. Although special characters are advantageous as they permit a larger number of standard characters to be used within each attribute, it should be apparent that one or more standard characters can be substituted therefor without departing from the spirit or the scope of the invention.

The attributes associated with each information display rule can include, but are not limited to, title, function, identifier, trigger type, button ID, dialog ID, and AVList. The title is typically included for informational purposes, and is generally used for debugging or the like. The function is a predetermined function type recognized by the helper application that instructs the helper application to generate, or to cause the browser to generate, an information window.

The identifier is a unique identifier associated with the information to be presented in a given information window. The identifier can be used for a variety of purposes, including, without limitation, determining whether the corresponding information window has previously been displayed by the client, and whether the information window has previously been displayed to the user. In an embodiment, the helper application, browser, or a third application can maintain a list of event-based information displays that have been presented by the client and/or to the user. By way of example, without intending to limit the present invention, such a list may be stored in the registry or other database associated with the client if the client is running a Windows based operating system distributed by Microsoft Corporation. Such a list can be used to prevent a particular event-based information display from being repeatedly presented to the same user and/or on the same client.

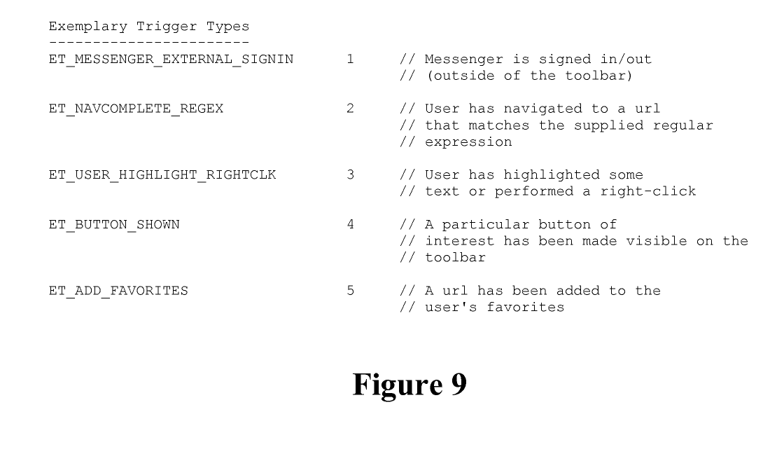

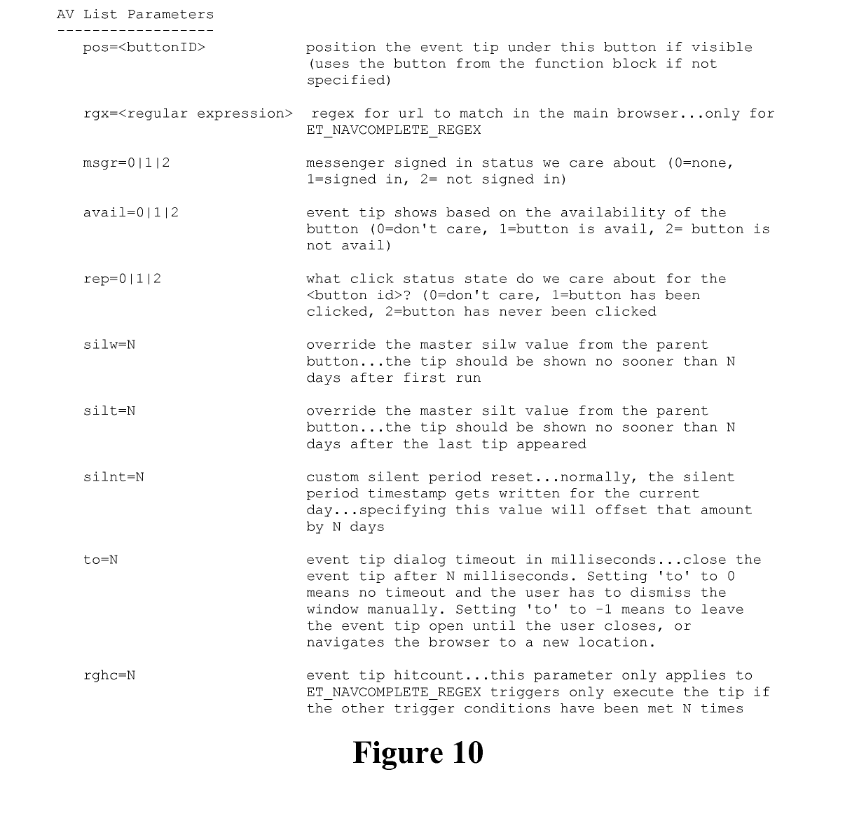

The trigger type is an identifier used to determine an event to which a given rule corresponds. This will be discussed in more detail below with respect to FIG. 9. The button ID is an identifier corresponding to a button or other user interface element in the browser or helper application, and allows the information window to be positioned proximate to that button if the button is being displayed by the browser or the helper application when the corresponding event is triggered. In an embodiment, the dialog ID can comprise a text string that is used in the body of the information window, including text to appear in any user interface element or elements present in the information window. In an alternative embodiment, the dialog ID can comprise a URL, a pointer to a URL stored in a look-up table, or other pointer to information to be displayed in the information window. In still another embodiment, the dialog ID comprises a unique key that corresponds to one or more HTML pages that have been stored locally on the client. In this embodiment, the HTML or other information to be displayed in the information window can be loaded in an inline frame, or iFrame, within the browser display, thereby permitting browser to display both the information window and the main browser content. The AVList is a list of keys and values, and is described below with respect to FIG. 10.

FIG. 9 is a table illustrating exemplary trigger types. As described above, the trigger types are used by the helper application to determine an event to which a given rule corresponds. By way of example, without intending to limit the present invention, an information display rule may include a trigger type of “1”, indicating that the rule should be processed when a specific external application triggers a particular event. When that event occurs, the AVList is processed to determine whether the rule should be executed.

FIG. 10 is a table illustrating exemplary AVList parameters that can be associated with an information window. Such AVList parameters can include, but are not limited to, pos, rgx, msgr, avail, rep, silw, silt, silnt, to, and rghc. Pos corresponds to a button ID or the like proximate to which the information window is to be positioned. Rgx is a regular expression which is used by the helper application to determine whether a URL which the user has accessed, the text displayed within the browser, a search string entered into the helper application, or the like is pertinent to a particular information window, and should thus trigger the display of the information window. Msgr is an attribute by which the helper application can be forced to ignore the user's login status as provided by an external application, or to require that the user be logged in/logged out of the external application before the information window will be displayed. Avail is an attribute by which the helper application can be forced to only display an information window based on the availability of a particular button or other user interface element within the browser or the helper application.

Rep is an attribute by which the helper application can be forced to only display an information window based on whether a button or other user interface element has previously been clicked or otherwise subject to user interaction. Silw is an attribute that allows the information window to occur more frequently or less frequently than the master Silw associated with the master information display rule. Silt is an attribute by which the master silt time can be overridden, thereby allowing the interval between when a previous information window was displayed and the information window associated with the rule to be altered from that specified in the master silt associated with the master information display rule. Silnt in an attribute by which the time stamp associated with the display of the current information window is altered, thereby allowing the interval between the display of the current information window and the display of the next information window to be modified. To is a timeout attribute, by which the duration the information window is displayed can be controlled. Rghc is a counting attribute by which the display of an information window can be postponed until the remaining trigger conditions have occurred at least some number of times.

The rep, silt, silw, silnt, to, and rghc AVList attributes can allow the helper application to present event-based displays at intervals that make them less intrusive, which in turn can allow the user to perceive the event-based displays as more helpful. Similarly, the rgx attribute allows the helper application to present event-based displays that are relevant to the specific user's interactions with the browser and/or helper application, again making the information presented therein more useful to the user.

While detailed and specific embodiments of the event-based display and methods therefor have been described herein, it will be apparent to those skilled in the art that various changes and modifications can be made therein without departing from the spirit and scope of the event-based display and methods therefor. Thus, it is intended that the present disclosure cover these modifications and variations provided they come within the scope of any appended claims and/or their equivalents.

What is claimed is:

1. A system for presenting pertinent information to a user, comprising:
at least one centralized server, wherein at least one rule is stored on the at least one centralized server;
a browser; and,
a helper application associated with the browser, wherein the helper application can retrieve the at least one rule from the at least one centralized server, wherein the helper application can monitor user events triggered by at least the browser and the helper application, wherein the helper application processes the at least one rule when an event is triggered, and wherein the helper application causes an event-based display to be generated based on the rule processing results.

2. The system of claim 1, wherein the event-based display is generated by the browser.

3. The system of claim 1, wherein the event-based display is generated based on information contained in the rule.

4. The system of claim 3, wherein the information contained in the rule comprises a URL.

5. The system of claim 3, wherein the information contained in the rule comprises HTML.

6. The system of claim 1, wherein the helper application is a plug-in to the browser.

7. The system of claim 1, wherein the helper application is additional functionality incorporated into the browser.

8. The system of claim 1, wherein the rules are stored as an XML feed.

9. The system of claim 1, wherein the rules are stored in a feed format that also supplies a list of functionality or features that can be provided by the helper application.

10. The system of claim 1, wherein the at least one rule comprises a regular expression.

11. The system of claim 10, wherein the helper application utilizes the regular expression to process a URL entered into the browser.

12. The system of claim 10, wherein the helper application utilizes the regular expression to process the contents of a browser window.

13. The system of claim 10, wherein the helper application utilizes the regular expression to process a search string.

14. The system of claim 13, wherein the search string is entered into the helper application.

15. The system of claim 1, wherein the at least one rule comprises at least one delay.

16. The system of claim 15, wherein the at least one delay comprises a master delay between presentation of a first event-based display and a second event-based display.

17. The system of claim 15, wherein the at least one delay comprises a modification of the time stamp corresponding to the presentation of an event-based display.

18. The system of claim 1, wherein the at least one rule comprises a number of times an event must be triggered before the rule will be executed.

19. The system of claim 1, wherein the browser runs on a client, and wherein at least a subset of the rule processing results are stored on the client.

20. The system of claim 1, wherein at least a subset of the rule processing results are stored on the centralized server.

21. The system of claim 20, wherein the helper application retrieves the subset of the rule processing results from the centralized server.

22. The system of claim 21, whereby the helper application avoids repeating causing an event-based display to be presented to a user as the user moves from client to client.

23. The system of claim 1, wherein the at least one rule changes when changes are made to the helper application.

24. The system of claim 1, wherein the at least one rule changes when changes are made to the browser.

25. The system of claim 1, wherein the helper application is a dynamic application.

26. The system of claim 25, wherein the at least one rule comprises a first rule which causes the generation of an event-based display, wherein the contents of the event-based display reflect changes made to the helper application.

27. The system of claim 26, wherein the changes made to the helper application comprise new features or functions.

28. A method of monitoring user interaction with a browser and presenting event-based displays relevant thereto, comprising:
waiting for an event to be triggered by the browser;
processing a rule set to determine if a rule exists that is pertinent to the event triggered by the browser; and,
causing an event-based display to be presented to the user.

29. The method of claim 28, further comprising obtaining the rule set from a centralized server.

30. The method of claim 29, wherein the rule set is obtained each time the browser is started.

31. The method of claim 28, wherein the rule set processing is performed by a helper application associated with the browser.

32. The method of claim 31, further comprising updating the rule set when changes are made to the helper application.

33. The method of claim 31, further comprising updating the rule set when changes are made to the browser.

34. The method of claim 31, further comprising waiting for an event to be triggered by the helper application.

35. The method of claim 28, further comprising waiting for an event to be triggered by an operating system in which the browser is running.

36. The method of claim 35, wherein the operating system triggers an event based on the passage of a period of time.
